(19) United States
(12) Patent Application Publication
(10) Pub. No.: US 2010/0265013 A1
(43) Pub. Date: Oct. 21, 2010

(54) Miniaturized Band-Pass Filter

(75) Inventor: In Ho Kang, Busan (KR)

Correspondence Address: INTELLECTUAL PROPERTY LAW GROUP LLP, 12 SOUTH FIRST STREET, SUITE 1205, SAN JOSE, CA, 95113, US

(73) Assignee: KOREA MARITIME UNIVERSITY INDUSTRY-ACADEMIC COOPER, YEONGDO-GU, BUSAN (KR)

(21) Appl. No.: 12/809,548

(22) PCT Filed: Dec. 22, 2008
(86) PCT No.: PCT/KR08/07587

§ 371 Date: Jun. 18, 2010

(30) Foreign Application Priority Data
Dec. 20, 2007 (KR) 10-2007-0136056
May 19, 2008 (KR) 10-2008-0046840

(51) Int. Cl. H01P 1/203

(52) U.S. Cl. 333/204

(57) ABSTRACT

Provided is a band-pass filter using a λ/4 transmission line. According to an embodiment of the present invention, a band-pass filter using a support layer formed of a semiconductor wafer, a circuit unit constructed on the support layer or between multilayered insulating layers formed on the support layer, and a λ/4 transmission line formed on the circuit unit includes: at least one miniaturized λ/4 transmission line with capacitors connected in parallel to an input/output connection portion of a coupled line with ends shorted in the diagonal direction; and a ground plane surrounding the band-pass filter.

### TECHNICAL FIELD

The present invention relates to a band-pass filter using a miniaturized λ/4 transmission line. In particular, the present invention is based on the inventions described in the Korean Patent Nos. 533907 and 726329 issued to the present applicant (hereinafter referred to as ‘antecedent patents’).

### BACKGROUND ART

Hereinafter, general technologies of the related art will be described in brief with reference to the accompanying drawings.

FIGS. 1 and 2 are equivalent circuit diagrams of miniaturized λ/4 transmission lines according to the related art. Also, FIGS. 2 and 4 are circuit diagrams of further-miniaturized λ/4 transmission lines according to the related art, and FIG. 5 is a circuit diagram illustrating an example of the use of a filter in a general communication system.

That is, FIG. 1 illustrates a general λ/4 transmission line according to the related art, and FIG. 2 illustrates a circuit diagram in which a 90° transmission line of FIG. 1 is miniaturized to a length θ.

Herein, the relationship between the transmission lines of FIGS. 1 and 2 can be expressed as Equations 1 and 2 below.

Z=Z₀/sin θ Equation 1

C₁=cos θ/ωZ₀ Equation 2

That is, this circuit is characterized in that, as the length θ of the miniaturized transmission line decreases, the transmission line characteristic impedance value increases rapidly, as can be seen from Equation 1. Generally, it can be seen that, if the characteristic impedance limit is 100Ω, it is very difficult to reduce the size below 30°.

Meanwhile, in FIG. 3, a resonant circuit is artificially inserted to make an equivalent circuit for a coupled line with ends shorted in the diagonal direction. Herein, a circuit indicated by a dotted line is an equivalent circuit for a coupled line with ends shorted, and the relationship therebetween can be expressed as Equations 3 to 6 below.

Z=2Z₀ₑZ₀ₒ/(Z₀ₑ−Z₀ₒ) Equation 3

L₀=Z₀ₑ tan θ/ω Equation 4

C₀=1/ω²L₀ Equation 5

C=C₁+C₀ Equation 6

Meanwhile, the reason for replacing the FIG. 2 transmission line with a length θ by the coupled line with ends shorted is that, however high an impedance Z value, the approximation of a Z₀ₑ value to a Z₀ₒ value can replace the impedance Z, as can be seen from Equation 3.

Also, FIG. 4 illustrates a further-miniaturized λ/4 transmission line, the concept of which is disclosed in the antecedent patents.

In order to show a general example of an ultrahigh-frequency filter, FIG. 5 illustrates an example of an RF communication system receiver/transmitter unit including a filter. Herein, a mobile communication system uses a duplexer or a switch at the rear end of an antenna. In this case, Surface Acoustic Wave (SAW) filters, LC filters, and Bulk Acoustic Wave (BAW) filters are mainly used as ultrahigh-frequency filters in mobile communication, WLAN, GPS, and satellite DMB systems.

Meanwhile, an RF unit of a communication system tends to use a Microwave Monolithic Integrated Circuit (MMIC) integrated through a semiconductor process, except a power amplifier and a filter. In practice, a filter is the hardest obstacle to overcome in the integration.

The existing technology fails to fabricate a filter by means of an MMIC. Thus, a filter is fabricated separately from an MMIC, and it must be externally connected for use.

In addition, as illustrated in FIG. 6, a transmission line has only to be connected for connection of a miniaturized λ/4 transmission line filter described in the antecedent patents. However, the use of only the transmission line makes it difficult to implement the band-pass characteristics in some specific circuits.

FIG. 7 illustrates the case where the connection of a miniaturized λ/4 transmission line, which has capacitors connected in parallel to an input/output connection portion of a coupled line with ends shorted in the diagonal direction in a CMOS 0.18 μm process, by means of only a transmission line is implemented on an Ansoft HFSS. This circuit is designed for 57 to 64 GHz ISM bands.

FIG. 8 is a sectional view of a signal line portion of a connection portion between two filters of FIG. 4. Herein, the sectional view is based on a general CMOS process.

Thus, a Si-substrate is disposed on the base of a wafer, an oxide layer SiO2 (i.e., an insulator) is disposed on the Si-substrate, and a conductor is used on or in the oxide layer to construct a circuit.

In FIG. 8, a ground plane of both ends of a signal line serves to prevent two miniaturized λ/4 transmission line filters from interfering with each other. Also, it can be seen from FIG. 7 that a signal of the connection portion between two filter circuits propagates in the form of coplanar transmission lines.

FIG. 9 illustrates the simulation result of the above circuit, which shows that the characteristics occur abnormally. That is, a distortion occurs in the total signal transmission because an interference occurs between two miniaturized λ/4 transmission line filters along the signal propagation line.

It can be seen that a similar distortion phenomenon occurs even when a circuit is constructed to transmit a signal along a transmission line in the form of FIG. 7 by replacing a miniaturized λ/4 transmission line with capacitors connected in parallel to the opposite input/output terminal of a coupled line with ends shorted in the same direction by a miniaturized λ/4 transmission line with capacitors connected in parallel to an input/output connection portion of a coupled line with ends shorted in the diagonal direction.

FIG. 10 illustrates the case where an input signal line is displaced instead of a transmission line and an output signal line is disposed under the input signal line, so that the connection of two miniaturized λ/4 transmission lines, implemented in a CMOS 0.18 μm process, by means of a Metal Insulator Metal (MIM) capacitor is implemented on an Ansoft HFSS.

FIG. 11 is a sectional view of the connection portion of FIG. 10, which is also possible even if input/output signal line planes are interchanged. It can be seen that a MIM capacitor is implemented between the input/output signal lines for signal transmission.

It can be seen from FIG. 12 that a serious characteristic distortion occurs even if the connection is made by the MIM capacitor. That is, a distortion occurs in the total signal transmission because an interference occurs between two miniaturized λ/4 transmission line filters along a condenser including two conductor layers propagating signals.

It can be seen that a similar distortion phenomenon occurs even when a circuit is constructed to transmit a signal along the two-layered condenser of FIG. 10 by replacing a miniaturized λ/4 transmission line with capacitors connected in parallel to the opposite input/output terminal of a coupled line with ends shorted in the same direction by a miniaturized λ/4 transmission line with capacitors connected in parallel to an input/output connection portion of a coupled line with ends shorted in the diagonal direction.

The antecedent patents show that, when a transmission line is connected between two miniaturized λ/4 transmission lines, a signal distortion is reduced to provide the normal band-pass characteristics. However, the use of only such a transmission line makes it impossible to implement the normal band-pass filter in a CMOS process, at a specific frequency, or in a specific circuit.

### DISCLOSURE

### Technical Problem

Accordingly, the present disclosure provides a band-pass filter using a miniaturized λ/4 transmission line, which is implemented through a CMOS process or a similar process.

The object of the present invention is not limited to the aforesaid, but other objects not described herein will be clearly understood by those skilled in the art from descriptions below.

### Technical Solution

According to an embodiment of the present invention, a band-pass filter using a support layer formed of a semiconductor wafer, a circuit unit constructed on the support layer or between multilayered insulating layers formed on the support layer, and a λ/4 transmission line formed on the circuit unit includes: at least one miniaturized λ/4 transmission line with capacitors connected in parallel to an input/output connection portion of a coupled line with ends shorted in the diagonal direction; and a ground plane surrounding the band-pass filter.

According to another embodiment of the present invention, a band-pass filter using a support layer formed of a semiconductor wafer, a circuit unit constructed on the support layer or between multilayered insulating layers formed on the support layer, and a λ/4 transmission line formed on the circuit unit includes: at least one miniaturized λ/4 transmission line with capacitors connected in parallel to the opposite input/output terminal of a coupled line with ends shorted in the same direction; and a ground plane surrounding the band-pass filter.

Herein, the λ/4 transmission line may include multilayered lines connected through a via hole.

In this case, at least one capacitor may be connected between the coupled lines in the miniaturized λ/4 transmission line. Also, at least one capacitor may be connected between the coupled lines by a connection line having a parallel vector component with respect to the coupled line.

The band-pass filter may further include a condenser (capacitor) disposed at the input or output connection line of the miniaturized λ/4 transmission line, or between the input terminal and the output terminal of the miniaturized λ/4 transmission line.

According to still another embodiment of the present invention, a band-pass filter using two miniaturized λ/4 transmission line filters includes: a ground plane disposed at both sides of a signal transmission road to suppress an interference between the two miniaturized λ/4 transmission line filters.

Herein, a transmission line may be disposed between the two miniaturized λ/4 transmission line filters to transmit a signal between the two miniaturized λ/4 transmission line filters.

Also, the ground plane may be disposed between the two miniaturized λ/4 transmission line filters and under or over the transmission line connected between the two miniaturized λ/4 transmission line filters, and the ground plane may be connected through a via hole to ground planes located at both sides of the ground plane.

Also, the band-pass filter may further include at least one inductor or condenser (capacitor) disposed at the transmission line between the two miniaturized λ/4 transmission line filters.

In this case, a conductor plane of one side line port of the miniaturized λ/4 transmission line filter and a conductor plane of the other side line port of the miniaturized λ/4 transmission line filter may operate as a condenser (capacitor) with respect to each other to transmit a signal between the two miniaturized λ/4 transmission line filters, and the signal may be transmitted through the condenser.

Herein, the ground plane may be disposed between the two miniaturized λ/4 transmission line filters and under or over a condenser including two conductor layers connected between the two miniaturized λ/4 transmission line filters, and the ground plane is connected through a via hole to ground planes located at both sides of the two conductor layers.

Also, the band-pass filter may further include at least one inductor or condenser (capacitor) disposed between the two miniaturized λ/4 transmission line filters, at the line over or under a two-layered condenser used for signal transmission.

### ADVANTAGEOUS EFFECTS

According to the band-pass filter using the λ/4 transmission line of the present invention described above, a filter can be fabricated by an MMIC through a semiconductor process in an ultrahigh-frequency or millimeter band, which is a long-cherished desire in the RF field.

Accordingly, the present invention can provide innovations in the component markets of wireless communication systems that are tending toward the widespread use of direct conversion at low power consumption and at a low maintenance cost.

Also, the present invention can greatly reduce the insertion loss of a filter, which is very important in a wireless communication system, while improving the in-band flatness.

### DESCRIPTION OF DRAWINGS

FIGS. 1 to 4 are diagrams illustrating an example of the circuit stricture of a λ/4 transmission line according to the related art.

FIG. 5 is a circuit diagram illustrating an example of the use of a filter in a general communication system.

FIG. 6 is a diagram illustrating an example of the transmission line connection structure according to the related art.

FIGS. 7 to 12 are diagrams illustrating the structure and characteristics of a band-pass filter using a λ/4 transmission line according to the related art.

FIGS. 13 to 39 are diagrams illustrating the structure and characteristics of a band-pass filter using a λ/4 transmission line according to exemplary embodiments of the present invention.

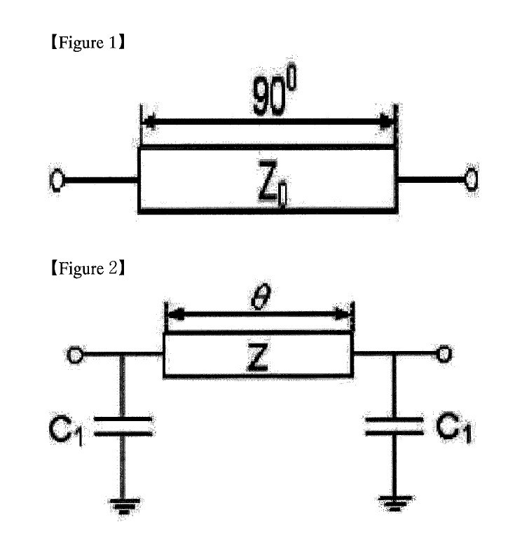

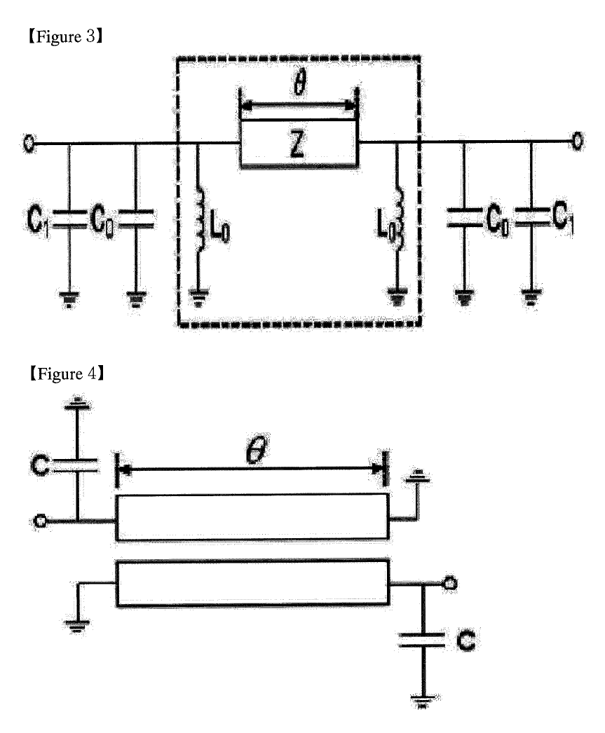

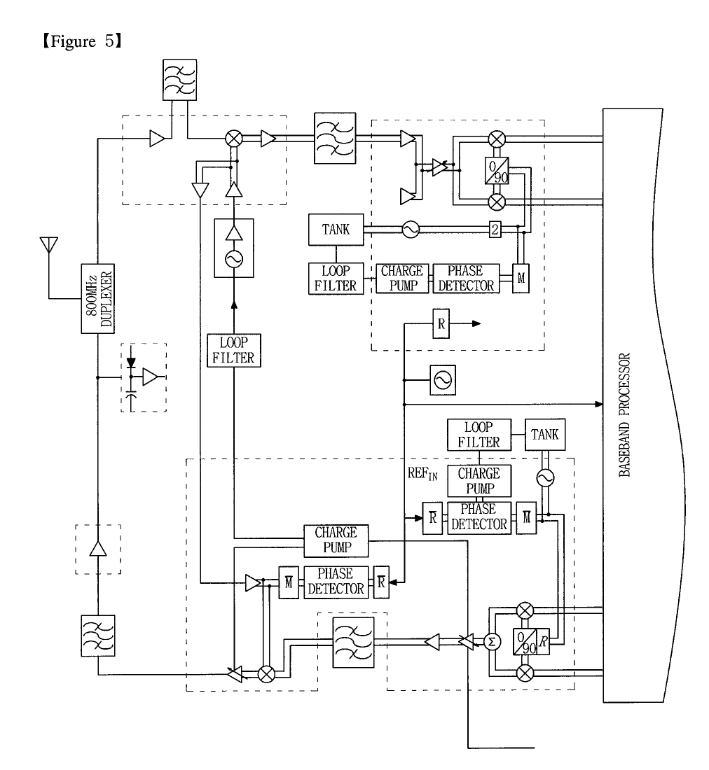

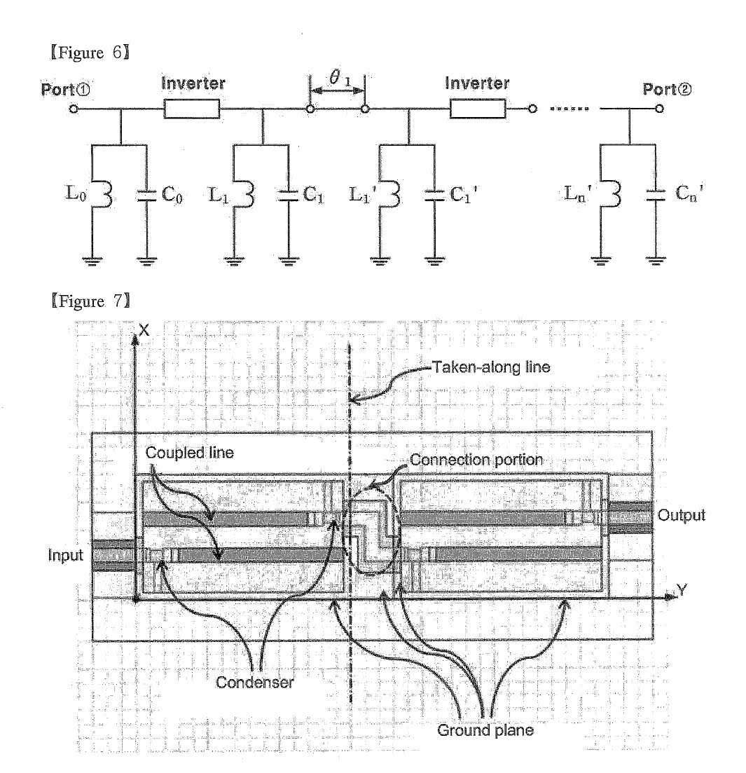

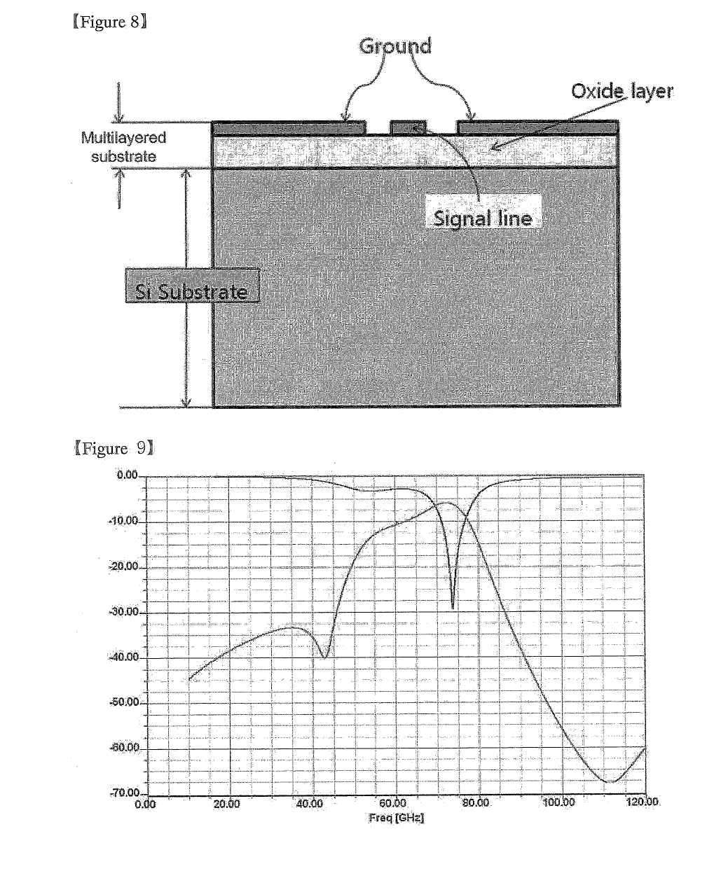

### BEST MODE

According to an embodiment of the present invention, a band-pass filter using a support layer formed of a semiconductor wafer, a circuit unit constructed on the support layer or between multilayered insulating layers formed on the support layer, and a λ/4 transmission line formed on the circuit unit includes: at least one miniaturized λ/4 transmission line with capacitors connected in parallel to an input/output connection portion of a coupled line with ends shorted in the diagonal direction; and a ground plane surrounding the band-pass filter.

According to another embodiment of the present invention, a band-pass filter using a support layer formed of a semiconductor wafer, a circuit unit constructed on the support layer or between multilayered insulating layers formed on the support layer, and a λ/4 transmission line formed on the circuit unit includes: at least one miniaturized λ/4 transmission line with capacitors connected in parallel to the opposite input/output terminal of a coupled line with ends shorted in the same direction; and a ground plane surrounding the band-pass filter.

According to still another embodiment of the present invention, a band-pass filter using two miniaturized λ/4 transmission line filters includes: a ground plane disposed at both sides of a signal transmission road to suppress an interference between the two miniaturized λ/4 transmission line filters.

Details of other embodiments are included in the detailed description and drawings. Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Also, though terms like a first, a second, and a third are used to describe various elements, components, and sections in various embodiments of the present invention, the elements, components and sections are not limited to these terms. These terms are used only to discriminate one element, component or section from another element, component or section. Therefore, a element, component or section referred to as a first element, component or section in one embodiment can be referred to as a second element, component or section in another embodiment.

In the following description, the technical terms are used only for explaining a specific exemplary embodiment while not limiting the present invention. The terms of a singular form may include plural forms unless otherwise specified. The meaning of “include,” “comprise,” “including,” or “comprising,” specifies a property, a region, a fixed number, a step, a process, an element or a component but does not exclude other properties, regions, fixed numbers, steps, processes, elements and/or components. Also, “A or B” means “A”, “B”, or “A and B.”

Hereinafter, exemplary embodiments of the present invention will be described in detail with reference to the accompanying drawings.

FIGS. 13 to 15 are diagrams illustrating the structure and characteristics of a band-pass filter using a λ/4 transmission line according to an exemplary embodiment of the present invention, which specifically illustrates a 5 GHz miniaturized band-pass filter designed in an HFSS on the basis of the characteristics of a CMOS process.

In FIG. 13, a reference numeral 1 denotes a ground plane surrounding the entire band-pass filter. A reference numeral 2 denotes a coupled line of the miniaturized filter. A reference numeral 3 denotes a condenser of the miniaturized filter. Reference numeral 4 and 5 respectively denotes an input terminal and an output terminal of the filter. A reference numeral 6 denotes a Si substrate of the filter. A reference numeral 7 denotes an air layer over the filter.

Referring to FIG. 13, because the filter is too small in comparison with the ground plane 1, the ground plane 1 is connected up to the sides of the input/output terminals in order to prevent an undesired connection with an external circuit.

Due to this structure, the band-pass filter using a λ/4 transmission line according to an exemplary embodiment of the present invention can have a shielding function for an external circuit in the process of shortening a miniaturized band-pass filter. This shielding ground plane may be implemented in a multilayered structure.

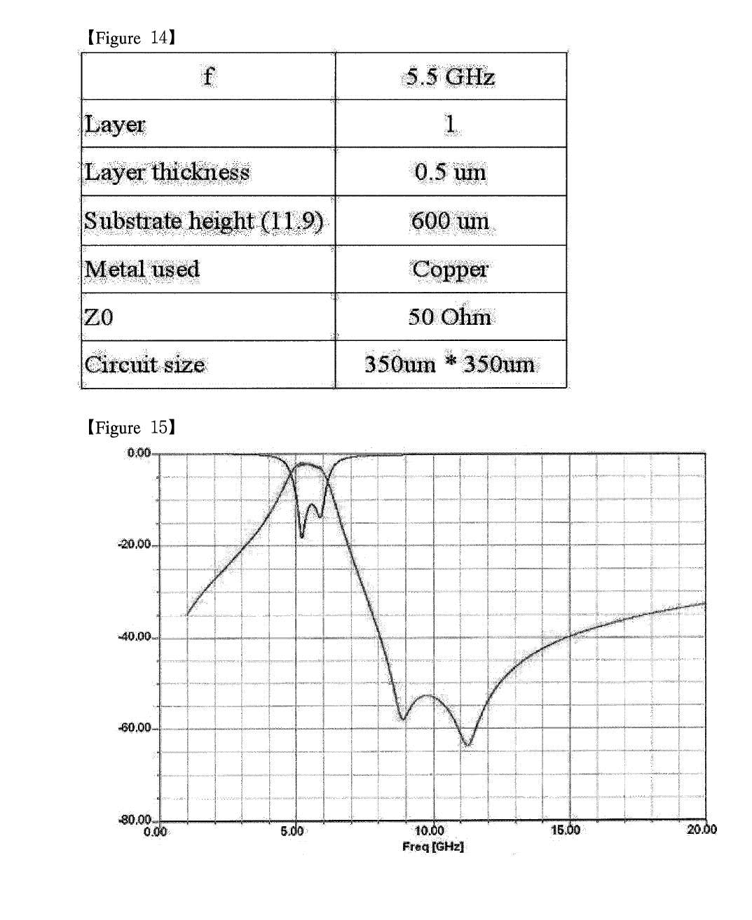

A detailed description of the above circuit is illustrated in FIG. 14. The performance characteristics of the filter are illustrated in FIG. 15. It can be seen from FIG. 15 that the filter of the present invention is similar in performance to the existing filter.

However, it can be seen from FIG. 15 that a transmission zero occurs at a high frequency (10 GHz) rather than at a center frequency. It is interpreted that the transmission zero occurs due to the resonance between the capacitive component of the coupled line and the equivalent inductive component caused when one end of the coupled line is grounded.

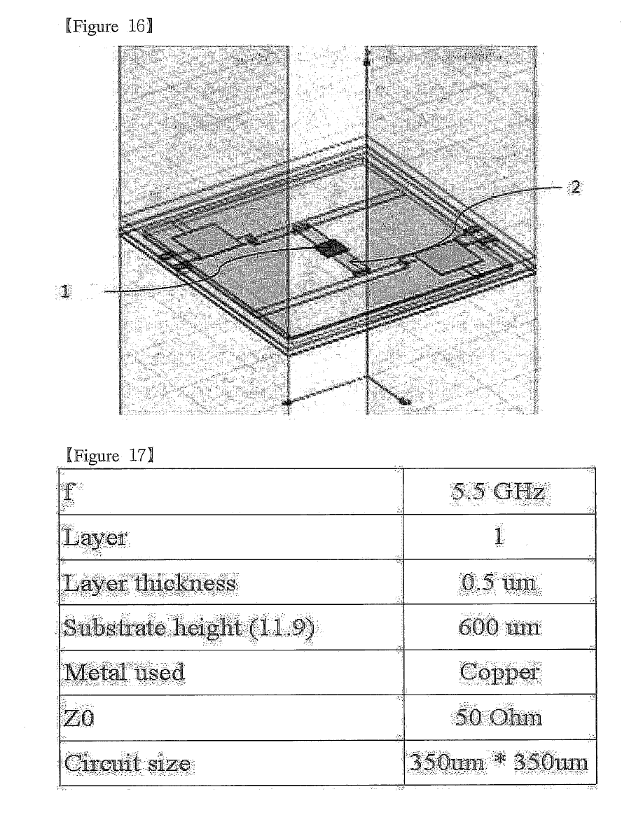

A circuit according to an embodiment of FIGS. 16 to 18 is provided to improve the imbalance (flatness characteristics) of an insertion loss in a pass band that occurs because the transmission zero of the band-pass filter using the λ/4 transmission line according to the embodiment of FIGS. 13 to 15 is located too close to the center frequency. In FIG. 16, a reference numeral 1 denotes a transmission zero control capacitor, and a reference numeral 2 denotes a capacitor connection line.

Because a wireless communication system does not need an image suppression filter at the front end of a mixer, it uses a filter only between an antenna, a low-noise amplifier and a power amplifier. The insertion loss of a filter in a receiver determines the noise characteristics of the low-noise amplifier, and the insertion loss of a filter in a transmitter determines the efficiency of the power amplifier, that is, the total communication-possible time period of a communication terminal. Thus, the insertion loss of the filter is one of the principal factors determining the total performance of the wireless communication system.

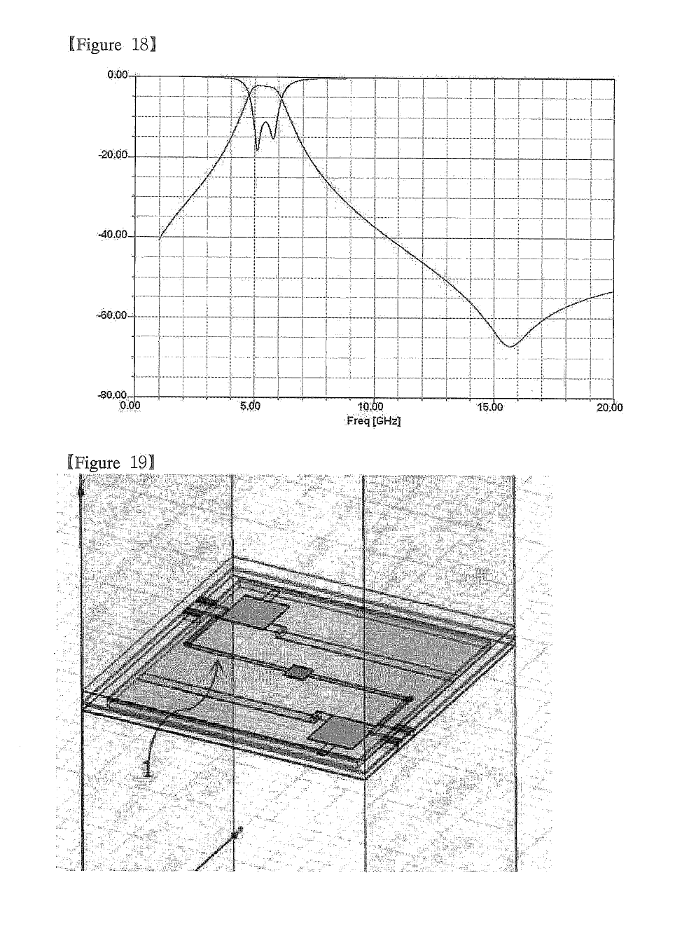

Referring to FIG. 16, a capacitor is connected to the center of a coupled line. In this case, a transmission zero frequency point shift right and thus a transmission zero occurs near 15 GHz, as can be seen from the characteristic graph of FIG. 18.

It can be seen that the frequency shift improves the flatness in the pass band by about 0.4 to 0.5 dB. Thus, it can be seen that the connection of the capacitor can improve the flatness.

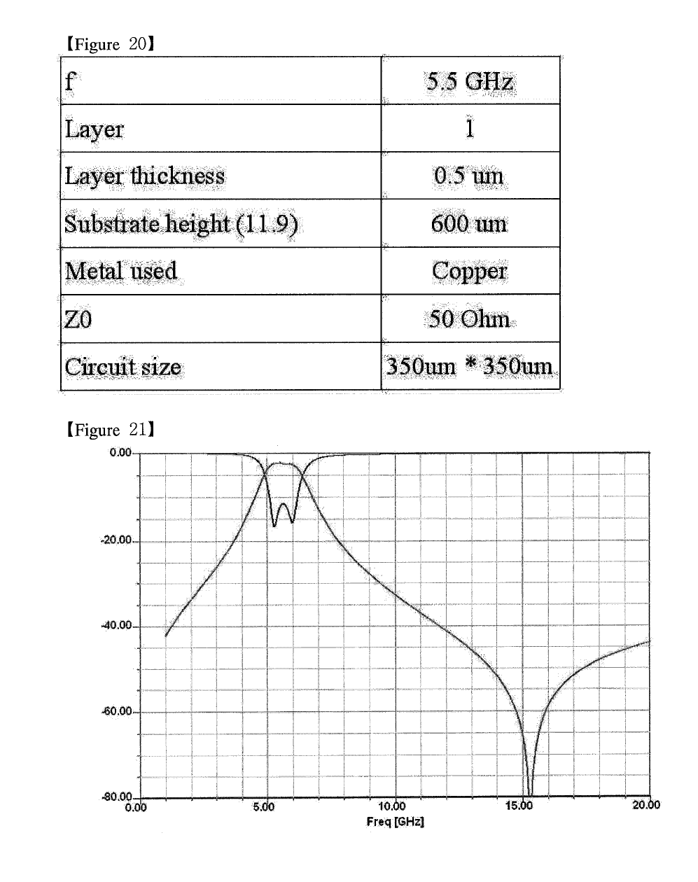

In order to further improve the flatness, a line is connected in the diagonal direction to add a capacitor, as illustrated in FIGS. 19 to 21.

It can be seen that the circuit of FIGS. 19 to 21 can further improve the flatness by 0.5 to 0.6 dB in comparison with the circuit of FIGS. 16 to 18. Thus, it can be seen that the flatness is improved when the capacitor is added because of a connection line parallel to a coupled line.

A reference numeral 1 in FIG. 19 denotes a structure that uses a line in the diagonal direction for connection of a capacitor between coupled lines.

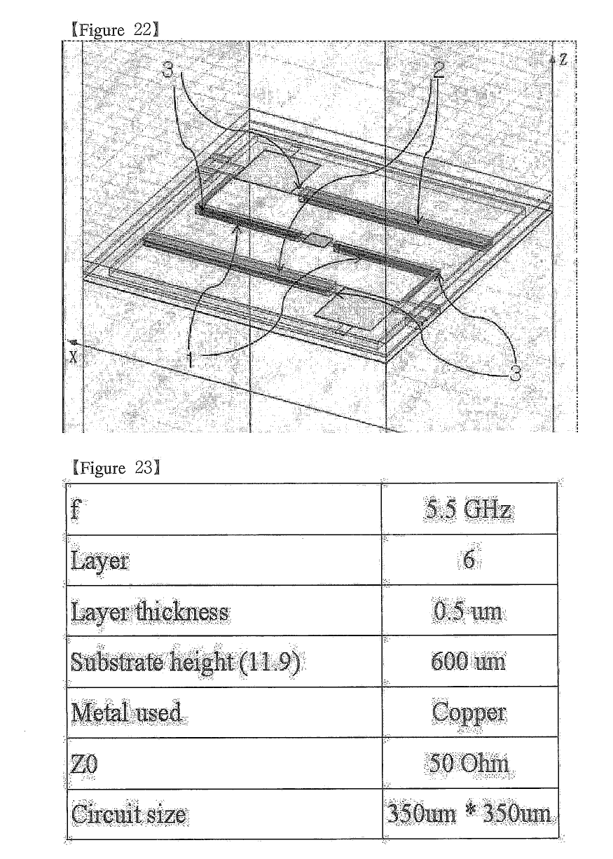

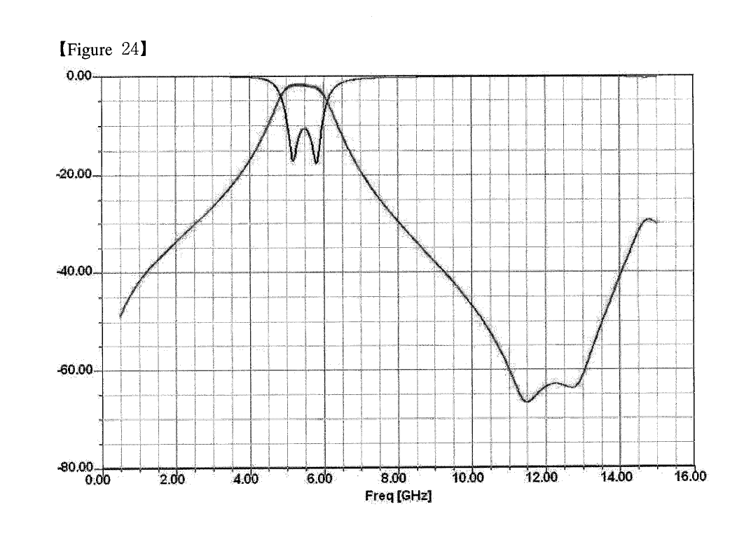

In order to further reduce the insertion loss in the circuit of FIGS. 19 to 21, multiple layers are used to connect a circuit to a coupled line and a connection circuit, as illustrated in FIGS. 22 to 24. In FIG. 22, reference numerals 1 and 2 respectively denote a six-layered line and a six-layered coupled line, and a reference numeral 3 denotes the location of a via hole.

It can be seen that the connection of the circuit by multiple layers remarkably reduces the insertion loss by 0.15 to 0.65 dB. It is interpreted that the insertion loss can be reduced because an attenuation component is reduced when a signal is transmitted through the multilayered path.

Herein, the six-layered line 1 and the six-layered coupled line 2 are merely an example according to the embodiment of the present invention, to which the present invention is not limited.

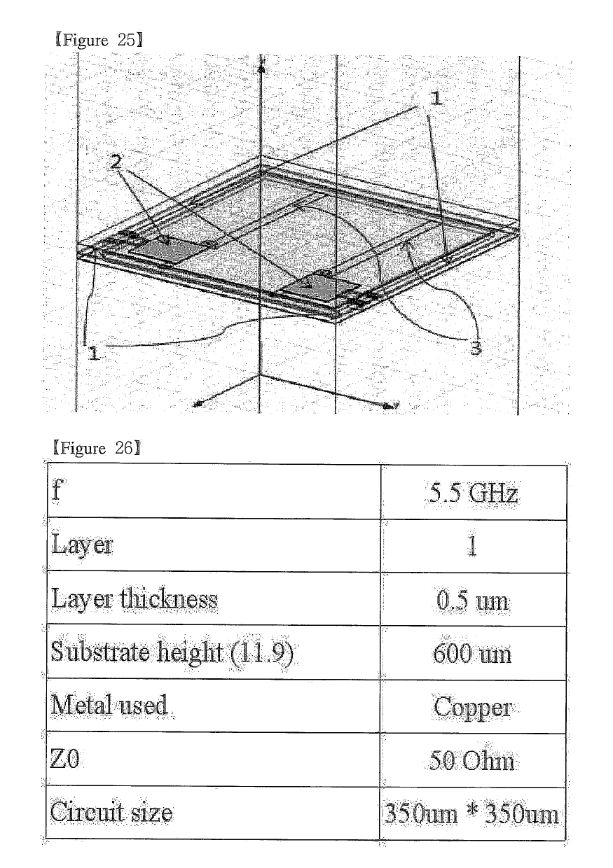

Even in the case where a miniaturized band-pass filter is implemented using a coupled line with ends grounded in the same direction, a ground plane surrounding the periphery may be used as illustrated in FIGS. 25 to 27.

In FIG. 25, a reference numeral 1 denotes a ground plane shielding the entire filter, a reference numeral 2 denotes a condenser, and a reference numeral 3 denotes a coupled line with ends grounded in the same direction.

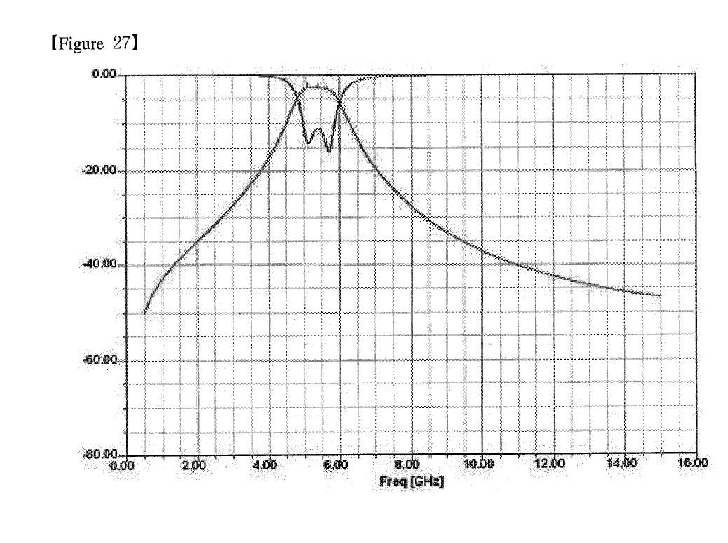

FIG. 27 is a performance characteristic graph showing the simulation result of a band-pass filter using a ground plane. Herein, the shielding ground plane may be implemented in a multilayered structure.

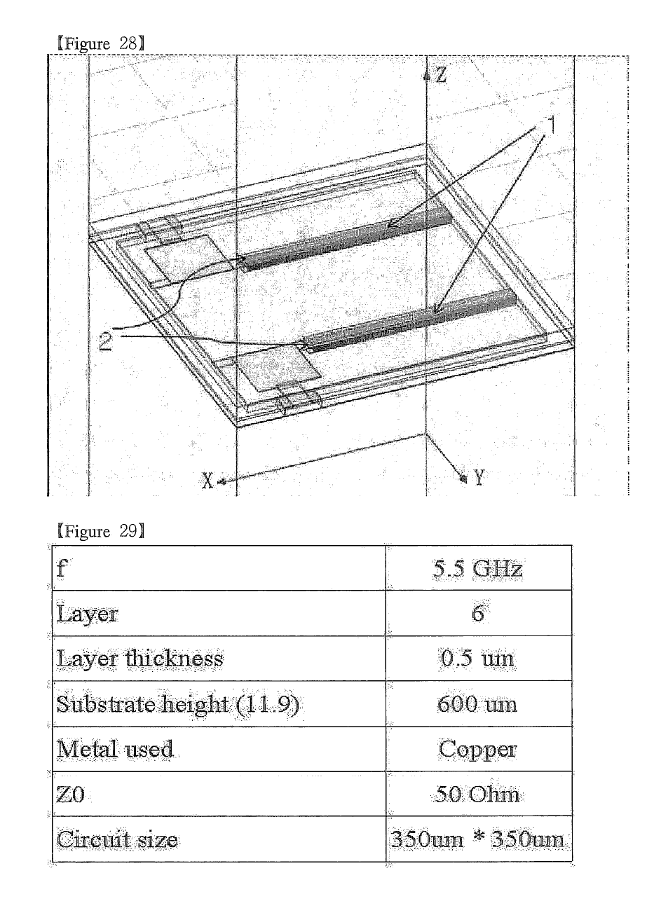

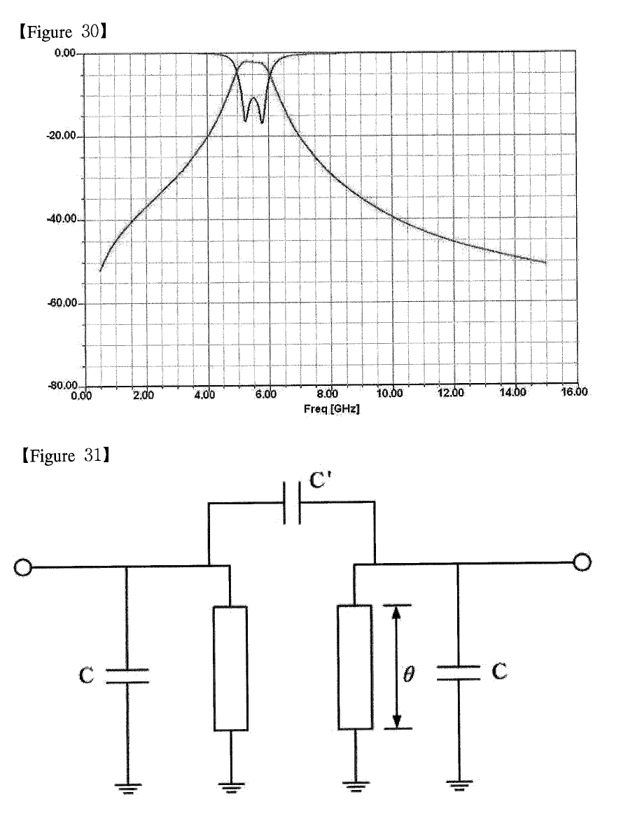

A circuit of FIGS. 25 to 27 is a filter using a coupled line with ends grounded in the same direction. In order to reduce the insertion loss of the band-pass filter with this structure, a coupled line of a band-pass filter is connected in a multilayered structure, as illustrated in FIGS. 28 and 29. It can be seen from FIG. 30 that the band-pass filter with this structure reduces the insertion loss by about 0.4 to 0.5 dB.

In FIG. 28, a reference numeral 1 denotes a coupled line connected in a multilayered structure, and a reference numeral 2 denotes the location of a via hole.

A condenser (capacitor) may be connected between coupled lines of a miniaturized λ/4 transmission line with this structure.

A condenser (capacitor) may be connected to an input or output terminal of a miniaturized λ/4 transmission line corresponding to a combination of a miniaturized λ/4 transmission line with capacitors connected in parallel to the opposite input/output terminal of a coupled line with ends shorted in the same direction and a miniaturized λ/4 transmission line with capacitors connected in parallel to an input/output connection portion of a coupled line with ends shorted in the diagonal direction. In addition, a condenser (capacitor) may be connected between the input and the output in this circuit.

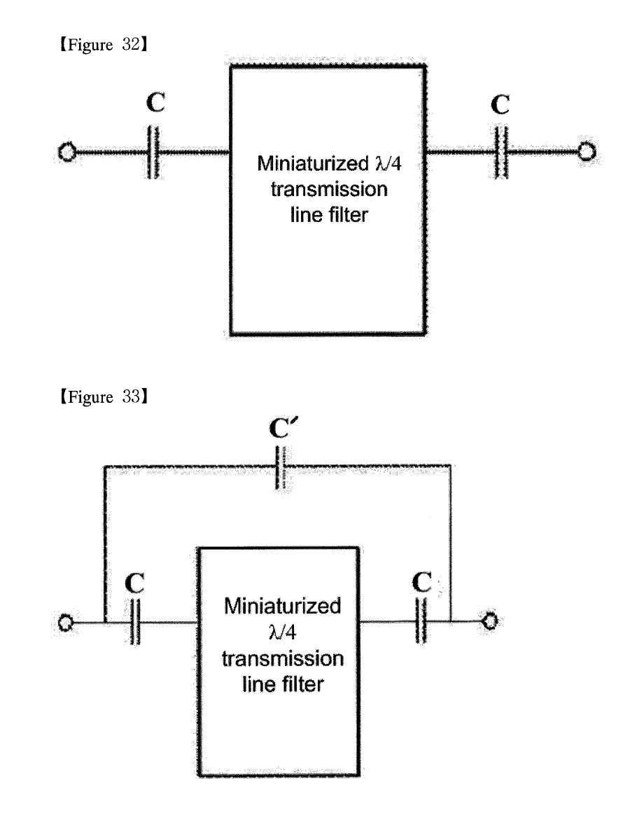

This structure is illustrated in FIGS. 31 to 33.

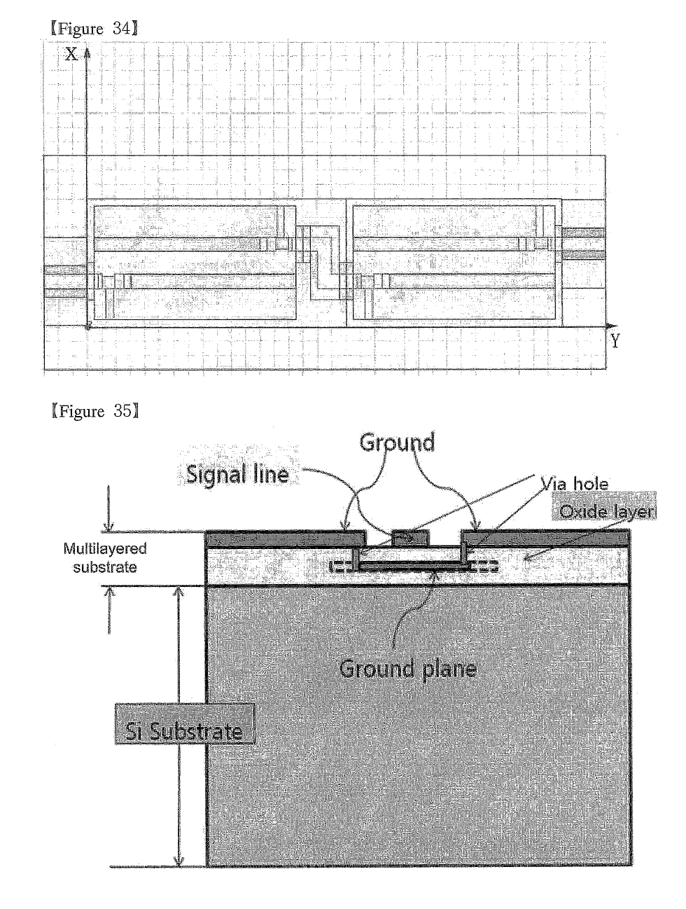

FIGS. 34 to 36 illustrate a circuit configured in such a way that a transmission line is disposed between two miniaturized λ/4 transmission line filters, a ground plane is disposed under or over a signal line and between the two miniaturized λ/4 transmission line filters, and the ground plane is connected through a via hole to ground planes located at both sides of the signal line.

As illustrated in FIGS. 34 and 35, a circuit is configured in such a way that both a transmission line and a ground plane are disposed between two miniaturized λ/4 transmission line filters. The reason for disposing the ground plane between the two miniaturized λ/4 transmission line filters, is to shield the circuit from an interference that is present under the signal line and between the two miniaturized λ/4 transmission line filters. The size of the shielding ground plane may be different under and over the transmission line.

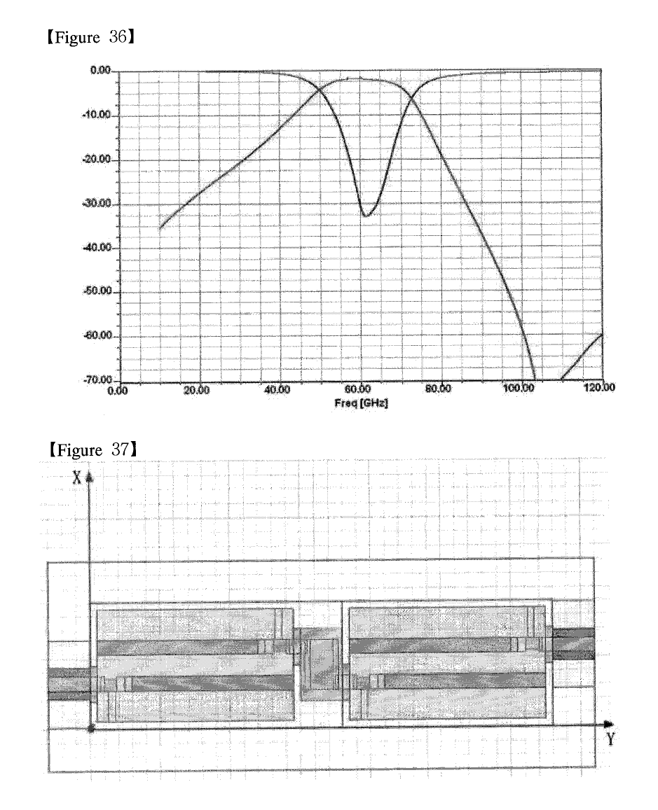

FIG. 36 shows the simulation result of the circuit of FIG. 34.

As can be seen from FIG. 36, when the ground plane is disposed under the signal line and between the two miniaturized λ/4 transmission line filters, a normal band-pass filter is constructed in a 57 to 64 GHz band. That is, it can be seen that the transmission line connected with the ground plane prevents an unnecessary coupling between the two miniaturized λ/4 transmission line filters.

It can be seen that the normal characteristics are obtained when the circuit is constructed in the same structure as FIG. 34 by replacing the miniaturized λ/4 transmission line with capacitors connected in parallel to the opposite input/output terminal of a coupled line with ends shorted in the same direction by the miniaturized λ/4 transmission line with capacitors connected in parallel to an input/output connection portion of a coupled line with ends shorted in the diagonal direction.

Herein, according to circumstances, a condenser (capacitor), an inductor and/or a resistor may be added to the transmission line disposed between the miniaturized filters.

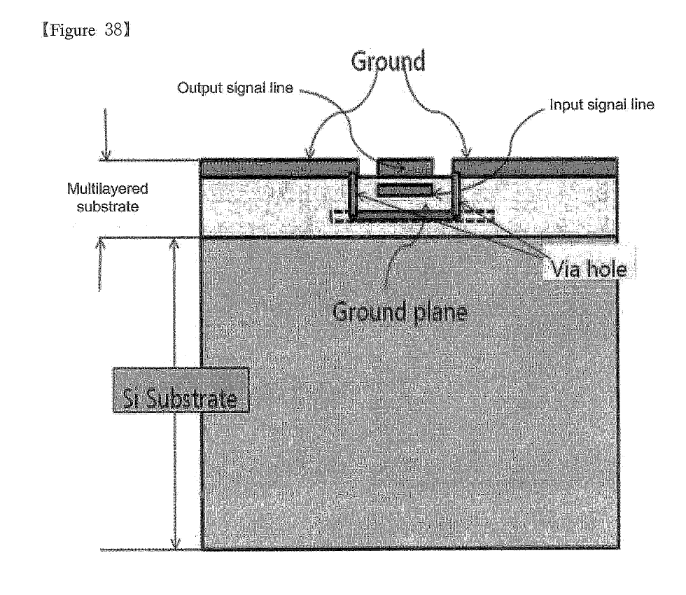

FIGS. 37 to 39 illustrate a circuit structure of disposing a ground plane between two miniaturized λ/4 transmission line filters in a band-pass filter where a MIM capacitor serving as a transmission line is inserted between two miniaturized λ/4 transmission lines.

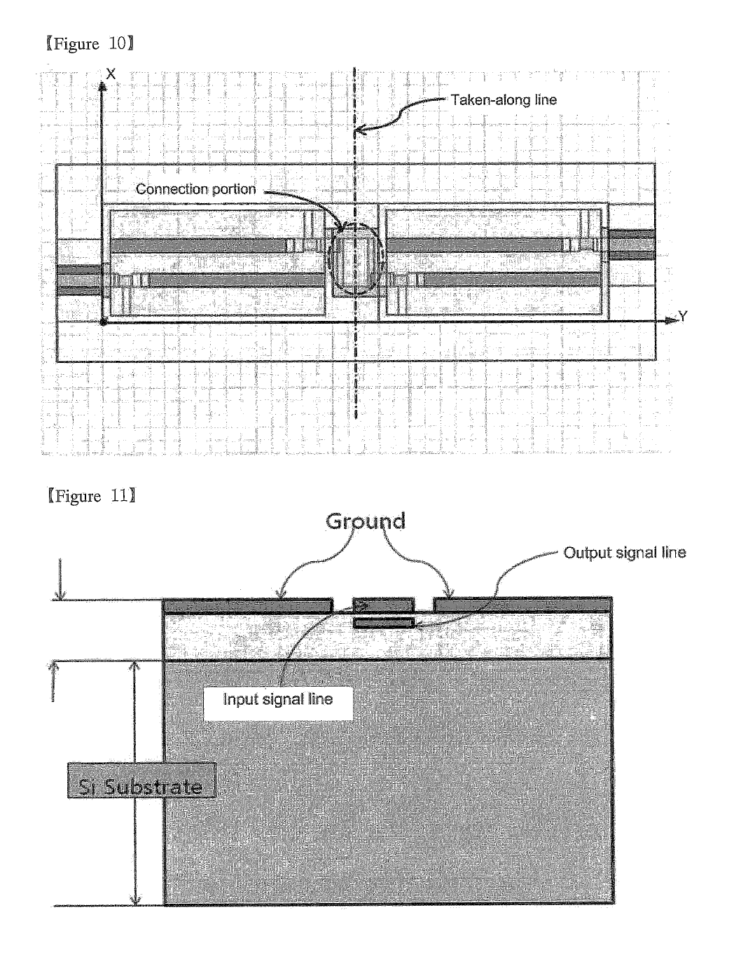

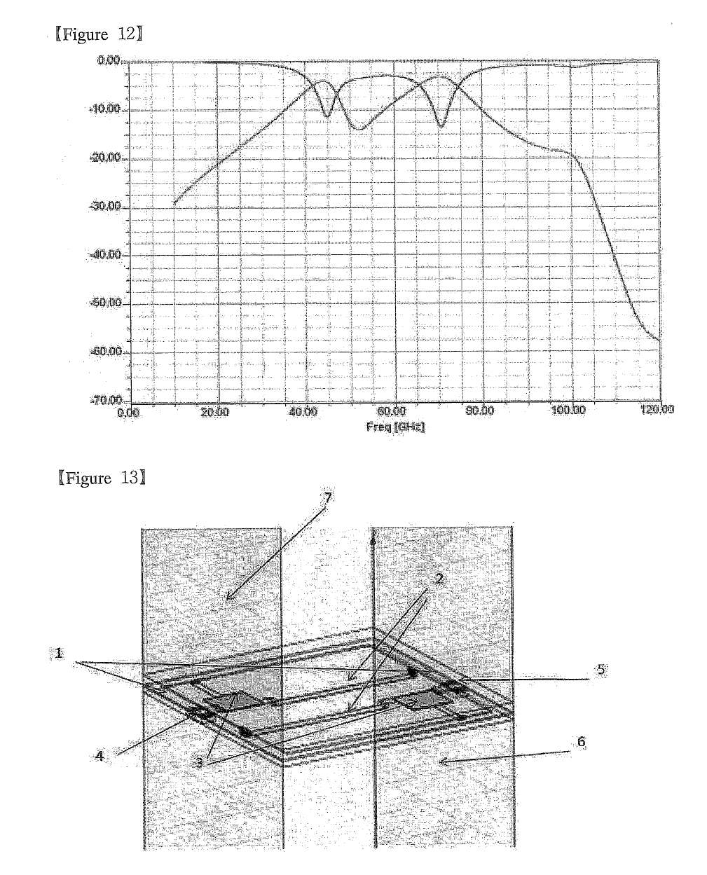

That is, FIGS. 37 to 39 illustrates the circuit structure capable of normalizing the abnormal filter characteristics of the related art circuit of FIGS. 10 to 12 by disposing the ground plane between the two miniaturized λ/4 transmission line filters.

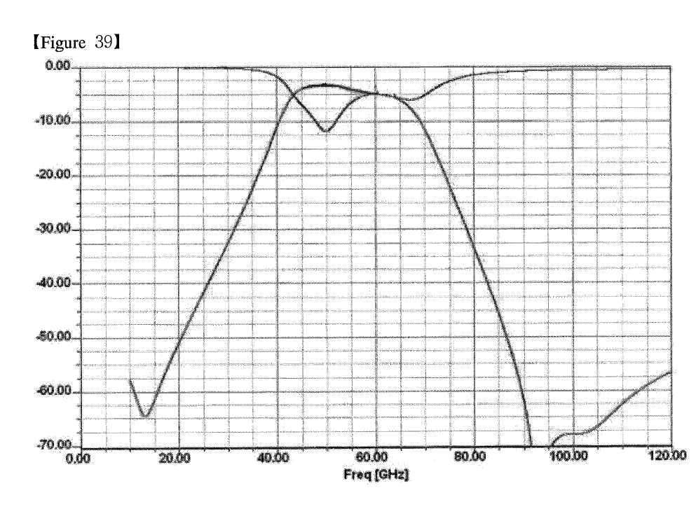

FIG. 38 illustrates a circuit configured in such a way that a ground plane is disposed under or over a signal line and between two miniaturized λ/4 transmission line filters, and the ground plane is connected through a via hole to ground planes located at both sides of the signal line. The design of the circuit on an HFSS is illustrated in FIG. 37, and the simulation result of the characteristics of the circuit is illustrated in FIG. 39.

It can be seen from FIG. 39 that the normal band-pass filter characteristics are obtained.

In this case, it can be seen that the normal characteristics are obtained when the circuit is constructed in the same structure as FIG. 37 by replacing the miniaturized λ/4 transmission line with capacitors connected in parallel to the opposite input/output terminal of a coupled line with ends shorted in the same direction by the miniaturized λ/4 transmission line with capacitors connected in parallel to an input/output connection portion of a coupled line with ends shorted in the diagonal direction.

Herein, according to circumstances, a condenser (capacitor), an inductor and/or a resistor may be added to the line disposed between the two miniaturized λ/4 transmission line filters and over or under an MIN condenser used for signal transmission.

While this invention has been particularly shown and described with reference to preferred embodiments thereof, it will be understood by those skilled in the art that various changes in form and details may be made therein without departing from the spirit and scope of the invention as defined by the appended claims.

1. A band-pass filter using a support layer formed of a semiconductor wafer, a circuit unit constructed on the support layer or between multilayered insulating layers formed on the support layer, and a λ/4 transmission line formed on the circuit unit, the band-pass filter comprising:
at least one miniaturized λ/4 transmission line with capacitors connected in parallel to an input/output connection portion of a coupled line with ends shorted in the diagonal direction; and
a ground plane surrounding the band-pass filter.

2. A band-pass filter using a support layer formed of a semiconductor wafer, a circuit unit constructed on the support layer or between multilayered insulating layers formed on the support layer, and a λ/4 transmission line formed on the circuit unit, the band-pass filter comprising:
at least one miniaturized λ/4 transmission line with capacitors connected in parallel to the opposite input/output terminal of a coupled line with ends shorted in the same direction; and
a ground plane surrounding the band-pass filter.

3. The band-pass filter of claim 1 or 2, wherein the λ/4 transmission line comprises multilayered lines connected through a via hole, regardless of a ground plane surrounding the band-pass filter.

4. The band-pass filter of claim 1 or 2, wherein at least one capacitor is connected between the coupled lines in the miniaturized λ/4 transmission line.

5. The band-pass filter of claim 1, wherein at least one capacitor is connected between the coupled lines by a connection line having a parallel vector component with respect to the coupled line.

6. The band-pass filter of claim 1 or 2, further comprising a condenser (capacitor) disposed at the input or output connection line of the miniaturized λ/4 transmission line.

7. The band-pass filter of claim 6, further comprising a condenser (capacitor) disposed between the input terminal and the output terminal of the miniaturized λ/4 transmission line.

8. A band-pass filter using two miniaturized λ/4 transmission line filters, the band-pass filter comprising:
a ground plane disposed at both sides of a signal transmission road to suppress an interference between the two miniaturized λ/4 transmission line filters.

9. The band-pass filter of claim 8, wherein a transmission line is disposed between the two miniaturized λ/4 transmission line filters to transmit a signal between the two miniaturized λ/4 transmission line filters.

10. The band-pass filter of claim 8, wherein the ground plane is disposed between the two miniaturized λ/4 transmission line filters and under or over the transmission line connected between the two miniaturized λ/4 transmission line filters, and the ground plane is connected through a via hole to ground planes located at both sides of the ground plane.

11. The band-pass filter of claim 10, further comprising at least one inductor or condenser (capacitor) disposed at the transmission line between the two miniaturized λ/4 transmission line filters.

12. The band-pass filter of claim 10, wherein a conductor plane of one side line port of the miniaturized λ/4 transmission line filter and a conductor plane of the other side line port of the miniaturized λ/4 transmission line filter operate as a condenser (capacitor) with respect to each other to transmit a signal between the two miniaturized λ/4 transmission line filters, and the signal is transmitted through the condenser.

13. The band-pass filter of claim 12, wherein the ground plane is disposed between the two miniaturized λ/4 transmission line filters and under or over a condenser including two conductor layers connected between the two miniaturized λ/4 transmission line filters, and the ground plane is connected through a via hole to ground planes located at both sides of the two conductor layers.

14. The band-pass filter of claim 13, further comprising at least one inductor or condenser (capacitor) disposed between the two miniaturized λ/4 transmission line filters, at the line over or under a two-layered condenser used for signal transmission.
